(19) United States
(12) Patent Application Publication
(10) Pub. No.: US 2015/0296919 A1
(43) Pub. Date: Oct. 22, 2015

(54) OVERSHOE COMPRISING AN EXPANDABLE OPENING AND METHOD OF PRODUCING SAME

(71) Applicant: 8215774 CANADA INC., Montreal (CA)

(72) Inventor: Marc KINGSLEY-POOLE, Montreal, Quebec (CA)

(21) Appl. No.: 14/410,404

(22) PCT Filed: Jun. 27, 2013
(86) PCT No.: PCT/CA2013/050505

§ 371 Date: Dec. 22, 2014

(30) Foreign Application Priority Data
Jun. 29, 2012 (CA) 2,782,059

(51) Int. Cl. A43B 3/16; B29D 35/00; A43B 7/12

(52) U.S. Cl. CPC A43B 3/16; A43B 7/12; B29D 35/0009; B29K 2101/12

(57) ABSTRACT

The present invention relates to an overshoe configured to receive a foot wearing an inner shoe. The overshoe comprises an overshoe body which includes a sole portion that is sealing connected with an upper portion. The overshoe further comprises an expansion portion which is sealingly and operatively coupled to the upper portion. The expansion portion is adapted to enable the overshoe body to reversibly acquire an open position and a closed position. When the expansion portion is in the open position the overshoe is configured for receiving the foot and inner shoe and when the expansion portion is in the closed position the overshoe is configured to substantially enclose around the received foot and inner shoe. Furthermore, the expansion portion includes a plurality of accordion style folds which are configured to bias at least in part towards the closed position.

### FIELD OF THE INVENTION

The present invention pertains to the field of footwear and in particular to an overshoe for accommodating footwear of different shapes and sizes.

### BACKGROUND

Throughout the course of a day, a person may be subject to a variety of social and meteorological contexts. When outside during inclement weather, including snow, rain and hail, or in flood, muddy or particularly dirty conditions, a person may desire to protect their footwear from exposure to such weather or conditions. A person may choose to have two alternative sets of footwear at their disposal throughout the day and to change footwear to suit the conditions. This requires always carrying the alternative set of footwear and the removal and fastening of a new set of footwear every time the weather or conditions warrant it. A person may choose to wear one set of footwear throughout such a day though it will likely be ill-suited to the social and meteorological contexts in which they may be.

Changing footwear poses a number of challenges to people. Each time that footwear is changed, a set of footwear must be removed and an alternative pair must then be fastened. For those with physical or mobility limitations, this may be painful or difficult or both. For those responsible for the care of children or children themselves, this can be time-consuming or frustrating or both.

Wearing overshoes eliminates the need to change footwear throughout the day. Footwear appropriate for dry weather or indoor use may be worn inside of an overshoe which is intended to protect the inner footwear from adverse weather and conditions. As the social and meteorological contexts vary, the overshoe may be removed and replaced as appropriate.

Overshoes come in a variety of types and vary in the means used to fasten them over the inner footwear. Some overshoes are fastened and affixed using only the elastic nature of the material of which they are composed. If this type of overshoe is too large, it will not remain securely fastened over the inner shoe, if it is too small, it may be possible but very challenging to fit the inner shoe into and achieve proper alignment of the inner shoe and overshoe. Even a properly sized overshoe may suffer from these same problems which can affect those with physical or mobility limitations.

Therefore there is a need for an overshoe that alleviates, at least in part, one or more of the deficiencies of existing overshoes.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide an overshoe comprising an expandable opening and method of producing same. In accordance with an aspect of the present invention, there is provided an overshoe configured to receive a foot wearing an inner shoe, the overshoe comprising: an overshoe body including a sole portion sealing connected with an upper portion; and an expansion portion sealingly and operatively coupled to the upper portion, the expansion portion adapted to enable the overshoe body to reversibly acquire an open position for receiving the foot and inner shoe and a closed position wherein the overshoe enclose around the received foot and inner shoe, said expansion portion including a plurality of accordion style folds, said accordion style folds bias the expansion portion at least in part towards the closed position.

In accordance with another aspect of the present invention, there is provided a method of fabricating an overshoe configured to receive a foot wearing an inner shoe, the overshoe comprising an overshoe body including a sole portion sealing connected with an upper portion; and an expansion portion sealingly and operatively coupled to the upper portion, the expansion portion adapted to enable the overshoe body to reversibly acquire an open position for receiving the foot and inner shoe and a closed position wherein the overshoe encloses around the received foot and inner shoe, said expansion portion including a plurality of accordion style folds, the method comprising the steps of: providing a mold having a cavity which defines the overshoe body and the expansion portion as a single unit; injecting material into the mold; and removing the mold.

In accordance with another aspect of the present invention, there is provided a molded overshoe for receiving a foot wearing an inner shoe capable of acquiring at least one open position for receiving the foot and inner shoe and at least one closed position wherein the overshoe body is closed and may be secured around the received foot and inner shoe. Said overshoe is composed from a single piece comprising: an expansion portion, a body portion a sole portion and a fastening portion. Said overshoe is predisposed to acquire at least one closed position. Said expansion portion is capable of altering the configuration of the overshoe to acquire at least one open position allowing the insertion of a foot wearing an inner shoe and upon insertion of afoot wearing an inner shoe, the overshoe is predisposed to acquire at least one closed position. Said fastening portion is capable of securing the overshoe in at least one closed position while containing a foot wearing an inner shoe and said sole portion comprises at least the portion of the overshoe in contact with the ground.

In accordance with another aspect of the present invention, there is provided a method of producing a molded overshoe comprising the use of a single mold to form a molded overshoe composed from a single piece comprising portions with different material thicknesses.

### BRIEF DESCRIPTION OF THE FIGURES

FIG. 1 illustrates a front perspective view of the overshoe in accordance with embodiments of the present invention.

FIG. 2 illustrates a rear perspective view of the overshoe in accordance with embodiments of the present invention.

FIG. 3 illustrates a side view of the overshoe in accordance with embodiments of the present invention, wherein the fastening portion is in a closed configuration.

FIG. 4 illustrates a side view of the overshoe in accordance with embodiments of the present invention, wherein the fastening portion is in an open configuration.

FIG. 5 illustrates a side view of the overshoe in accordance with embodiments of the present invention, wherein the fastening portion is in a closed configuration.

FIG. 6 illustrates a side view of the overshoe in accordance with embodiments of the present invention, wherein the fastening portion is in an open configuration.

FIG. 7 illustrates a front view of the overshoe in accordance with embodiments of the present invention.

FIG. 8 illustrates a rear view of the overshoe in accordance with embodiments of the present invention.

FIG. 9 illustrates a bottom view of the overshoe in accordance with embodiments of the present invention.

FIG. 10 illustrates a top view of the overshoe in accordance with embodiments of the present invention, wherein the fastening portion is in a closed position.

FIG. 11 illustrates a top view of the overshoe in accordance with embodiments of the present invention, wherein the fastening portion is in an open position.

FIG. 12 illustrates another top view of the overshoe in accordance with embodiments of the present invention, wherein the fastening portion is in an open position.

FIG. 13 illustrates a side view of the overshoe in accordance with embodiments of the present invention, wherein different locations along the expansion portion are identified.

FIG. 14 illustrates a cross sectional view of the expansion portion at different locations of the overshoe illustrated in FIG. 13.

FIG. 15 illustrates a top view and associated side profile view of the expansion portion of the overshoe in accordance with embodiments of the present invention.

FIG. 16 illustrates another top view and associated side profile view of the expansion portion of the overshoe in accordance with embodiments of the present invention.

### DETAILED DESCRIPTION OF THE INVENTION

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

The present invention relates to an overshoe configured to receive a foot wearing an inner shoe. The overshoe comprises an overshoe body which includes a sole portion that is sealingly connected with an upper portion. The overshoe further comprises an expansion portion which is sealingly and operatively coupled to the upper portion. The expansion portion is adapted to enable the overshoe body to reversibly acquire an open position and a closed position, for example the overshoe body is reconfigurable between an open and closed position. As such, the overshoe body and the expansion portion define a cavity having an adjustable volume. When the expansion portion is in the open position the overshoe is configured for receiving the foot and inner shoe and when the expansion portion is in the closed position the overshoe is configured to substantially enclose around the received foot and inner shoe. Furthermore, the expansion portion includes a plurality of accordion style folds which are configured to bias the expansion portion at least in part towards the closed position.

According to embodiments, the overshoe further comprises a fastening portion that can be configured to retain the expansion portion of the overshoe in the closed positioned. A first end of the fastening portion can be substantially fixedly secured to the upper portion of the overshoe at a first location, and a second end of the fastening portion is substantially detachably connected to the upper portion of the overshoe at a second location. In this manner, by detaching the fastening portion at the second location, the expansion portion can be permitted to move from the closed position to the open position, upon application of a suitable force to enable this movement. In another embodiment, the fastening portion is substantially detachable from the upper portion of the overshoe body at both the first location and the second location.

The overshoe body comprises an outer surface and an inner surface, wherein the outer surface is generally the surface which comes in contact with external debris and other matter, for example rain, snow, dirt and the like, typically when the overshoe in use. The inner surface of the overshoe body is generally the surface which faces the user's leg, foot and inner shoe, when in use. It will be readily understood that the inner surface and the outer surface may be of the same material, or for example in an instance where the overshoe has an inner lining, the inner surface may be of different material than the outer surface.

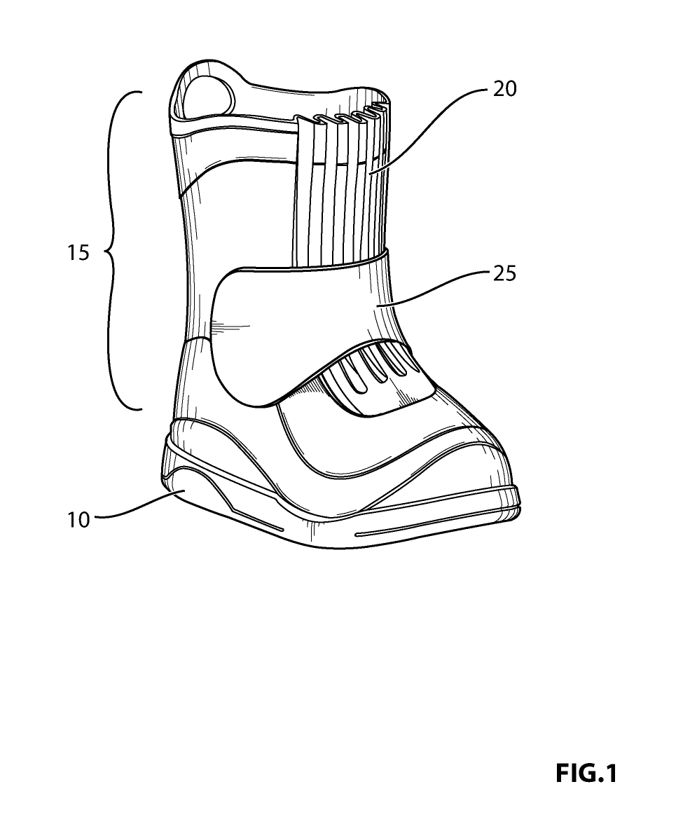

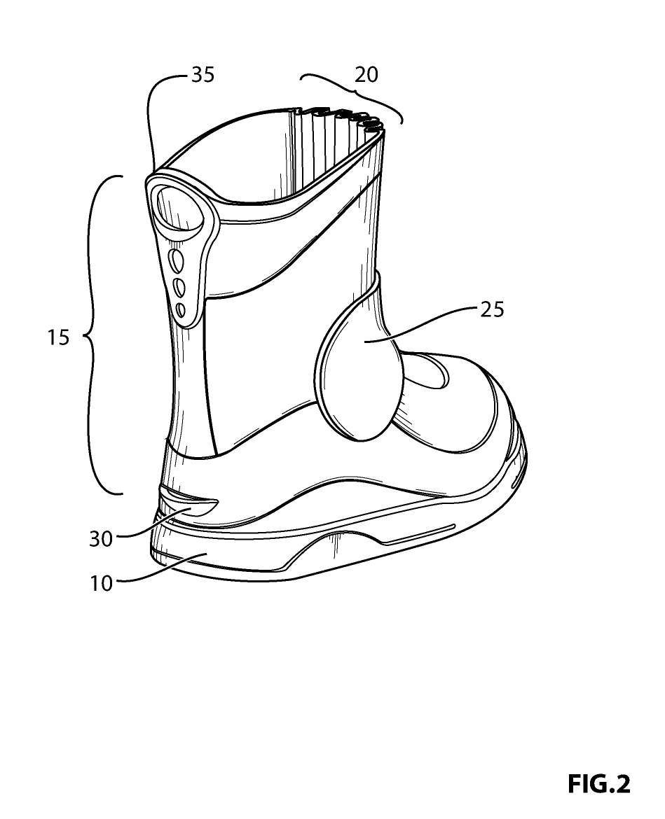

FIGS. 1 and 2 illustrate front and rear perspective views of the overshoe according to embodiments of the present invention. The overshoe includes an overshoe body, which comprises a sole portion 10 and an upper portion 15. The overshoe further includes a expansion portion 20 which is sealing connected with the upper portion. The expansion portion includes a plurality of accordion style folds. In some embodiments, the overshoe further includes a fastening portion 25, which configured to provide additional force to maintain the expansion portion in the closed position. In some embodiments, the biasing nature of the expansion portion, namely the plurality of accordion style folds which at least in part bias the expansion portion towards the closed position, provide a desired amount of closure of the expansion portion and thus some embodiments of the overshoe may not require the inclusion of the fastening portion.

In some embodiments, the overshoe further includes an abutment 30, which is positioned and configured for the attachment of auxiliary devices, for example a traction device or other auxiliary device as would be readily understood. According to some embodiments, the abutment 30 may provide an enhancement for the removal of the inner shoe and foot of the user from within the overshoe, wherein the abutment can provide a bracing location for the other foot of the user to be positioned during the removal process. In some embodiments, the overshoe further includes a gripping portion 35, which is configured to aid the user during the insertion of the inner shoe and foot of the user. The gripping portion can be configured as a tab for gripping by the user or a tab with an aperture for insertion of one a more fingers of a user there through. Other forms of the gripping portion would be readily understood by a worker skilled in the art.

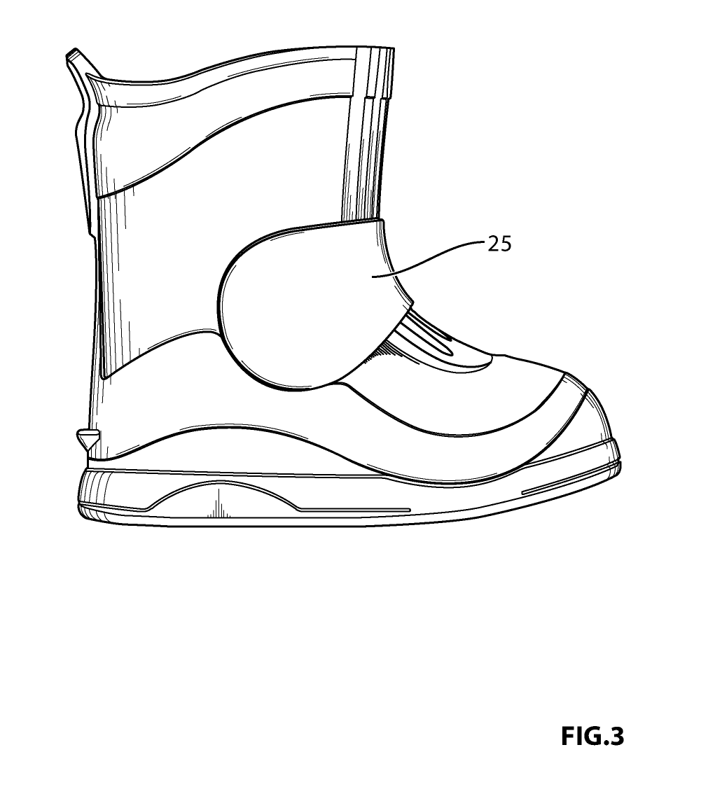

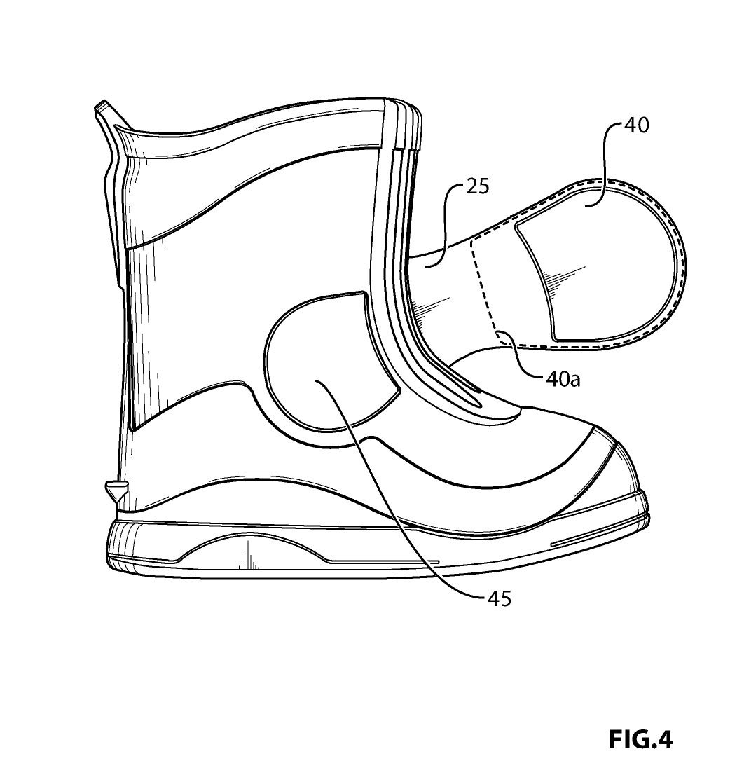

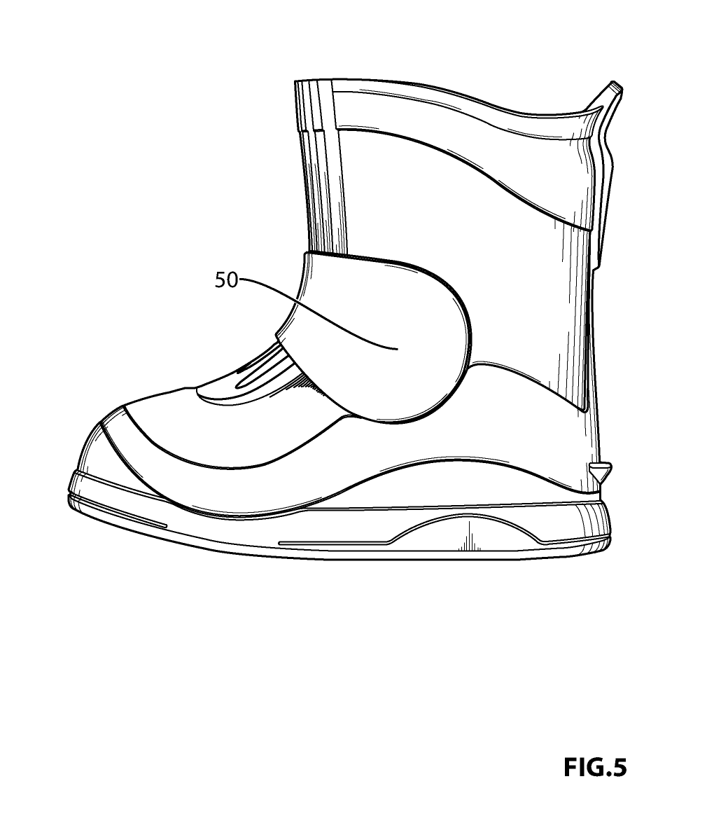

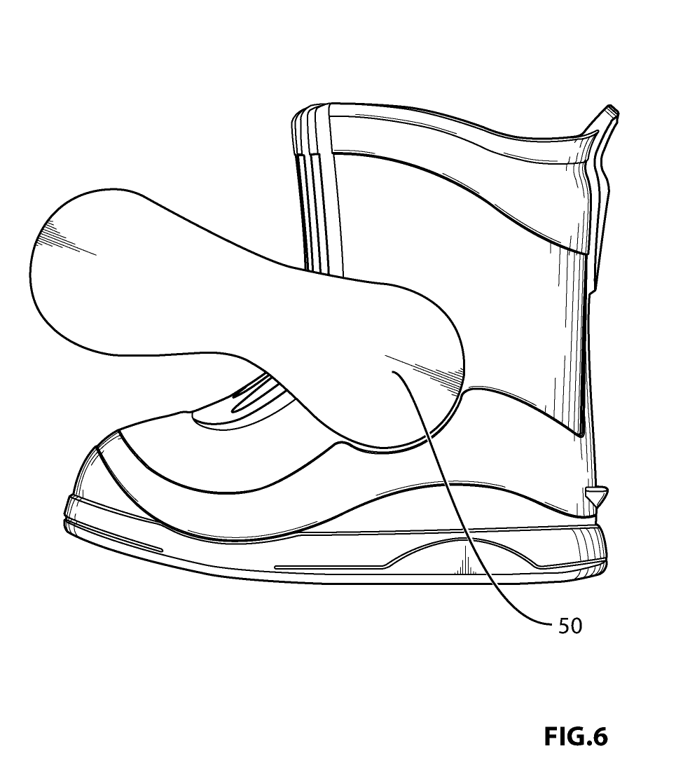

FIGS. 3 and 4 illustrate a first side view of the overshoe and FIGS. 5 and 6 illustrate a second side view of the overshoe in accordance with embodiments of the present invention. In particular, FIGS. 3 and 5, illustrate side views wherein the fastening portion is in a closed configuration and FIGS. 4 and 6 illustrate side views wherein the fastening portion is in an open position.

With further reference to FIG. 4, the fastening portion 25 includes a securing mechanism which is configured as a combination of a first securing mechanism 40 and a second securing mechanism 45 which cooperate together to provide the desired reversible connection between the upper portion of the overshoe and the fastening portion. In some embodiments, the securing mechanism includes a hook and eye type fastener, for example Velcro™, wherein the hook portion can be provided as the first securing mechanism and the eye portion can be provided as the second securing mechanism, or vice versa. As illustrated in FIG. 4, the first securing mechanism 40 can be provided over a larger surface area 40a relative to the second securing mechanism 45, which can enable a level of adjustment of the fastening portion at engagement of the securing mechanism. For example, this can provide a user of the overshoe the ability to manage the degree of closure force applied by the fastening portion on the expansion portion and ultimately on the foot of the user.

According to embodiments of the present invention, the securing mechanism may be configured in other detachable formats as would be readily understood. For example, the securing mechanism can be configured as a belt-buckle arrangement, snap socket and snap head combination or other releasable or detachable format as would be known to a worker skilled in the art.

According to some embodiments of the present invention, the fastening portion is fixedly secured to the upper portion of the overshoe body on the instep side of overshoe. In this manner, the operation of the securing mechanism is provided on the opposite side of the overshoe, enabling more ease of access to the user, as the securing mechanism is provided at a location proximate the outside of the foot. As an example, FIG. 6 illustrates the fastening portion in an open position, and is fixedly connected to the upper portion of the overshoe body at the second location 50.

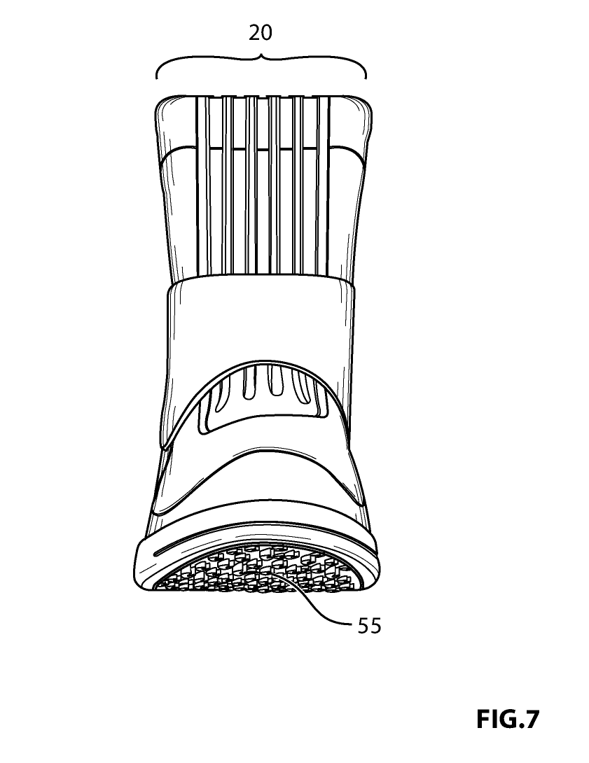

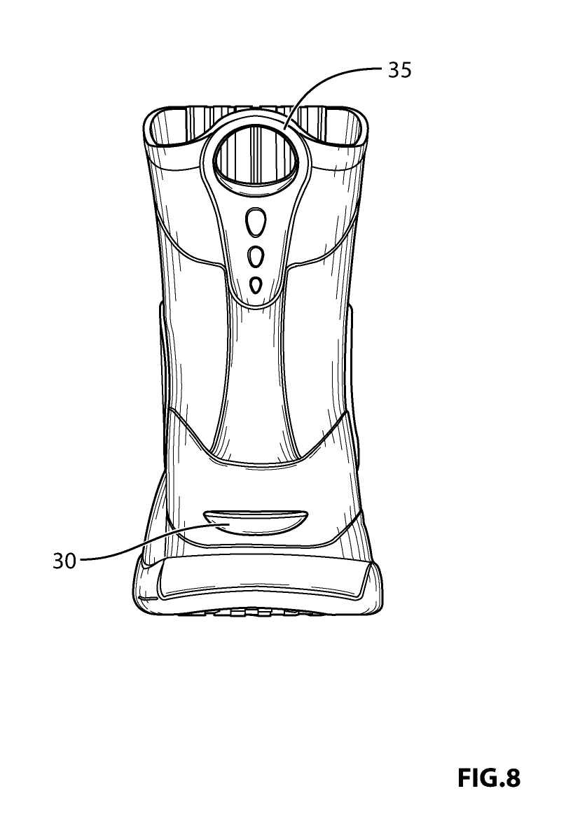

FIG. 7 illustrates a front view of the overshoe in accordance with embodiments of the present invention. In this figure, the bottom of the sole portion of the overshoe is visible wherein a tread pattern 55 can be seen. According to embodiments of the present invention, the sole portion of the overshoe body can have a curvature formed therein which can provide for ease of walking in the overshoe. As illustrated, in a region from approximately the ball of the foot region to the toe region of the overshoe, an upward curvature of the sole portion is provided, thereby decreasing the required flexion of the sole portion during walking. In some embodiments, as illustrated in FIG. 8, the sole portion may further comprise a curvature therein proximate the heel region of the overshoe, which may additionally provide ease of walking at the heel striking stage of the user's stride.

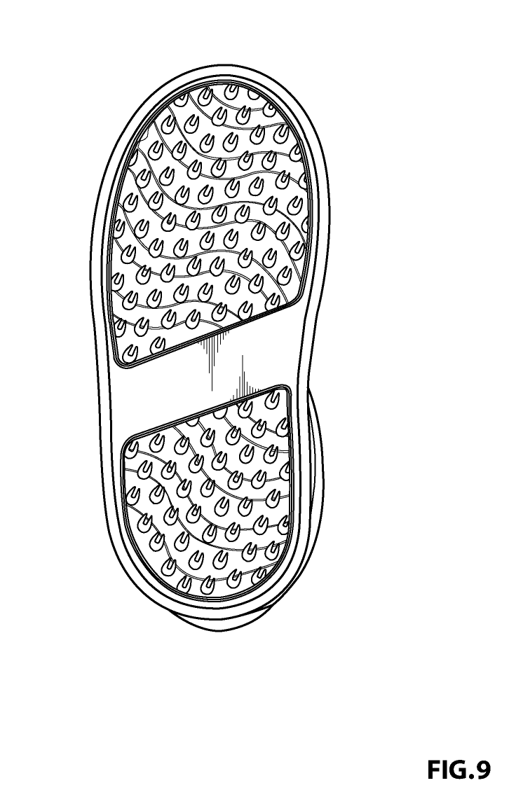

FIG. 9 illustrates a tread pattern for the overshoe in accordance with some embodiments of the present invention, however, the overshoe can be provided with any of a wide variety of tread patterns as would be readily understood by a worker skilled in the art. The tread pattern can be determined based on the typical conditions for use of the overshoe, for example, mud, snow, rain, urban conditions or the like.

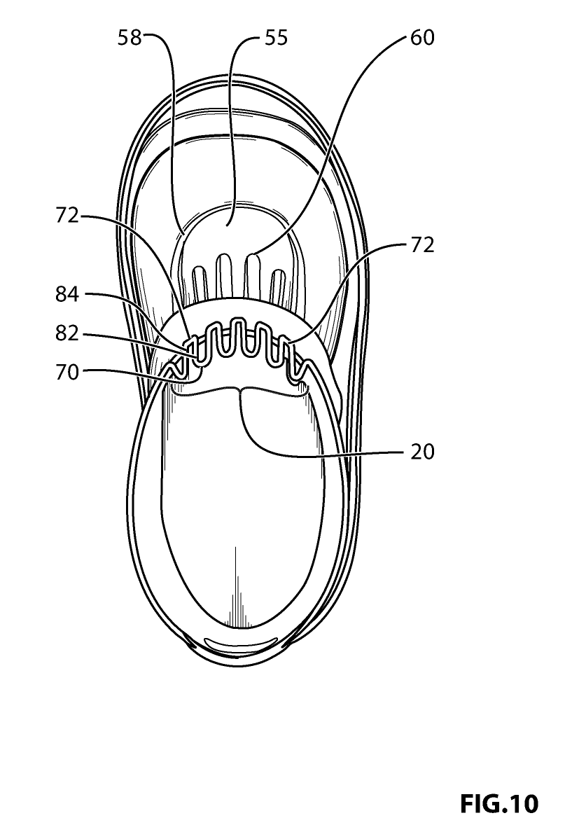

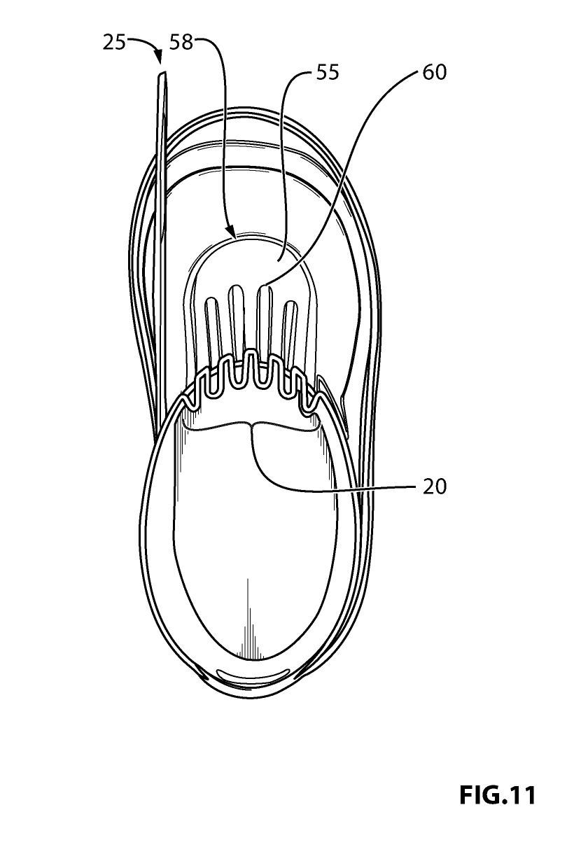

FIGS. 10 and 11 illustrate top views of the overshoe in accordance with embodiments of the present invention, wherein the fastening portion is in the closed and open position, respectively. Having regard to these figures, there is defined in the upper portion of the overshoe body a flexibility transition 58, wherein the thickness of the upper portion changes. The interior portion 55, 55a defined by the flexibility transition, will have a thickness that is less than the outer portion, which can provide a level of flexibility of the upper portion of the overshoe body, during the expansion and contraction of the expansion portion 20.

### Expansion Portion

The expansion portion is sealingly and operatively coupled to the upper portion of the overshoe body and is adapted to enable the overshoe body to reversibly acquire an open position and a closed position. When the expansion portion is in the open position the overshoe is configured for receiving the foot and inner shoe of a user and when the expansion portion is in the closed position the overshoe is configured to substantially enclose around the received foot and inner shoe. The expansion portion includes a plurality of accordion style folds which are configured to bias at least in part towards the closed position.

According to embodiments of the present invention, the expansion portion is located at the tongue region, which is substantially where a tongue of a shoe or boot would be positioned. In alternate embodiments, the expansion portion is positioned at the heel of the overshoe. In yet other embodiments, the expansion portion is positioned at one or both sides of the overshoe. In some embodiments, a primary expansion portion is located at the tongue region and a secondary expansion portion may be positioned at a side of the overshoe in order to provide secondary expansion of the overshoe.

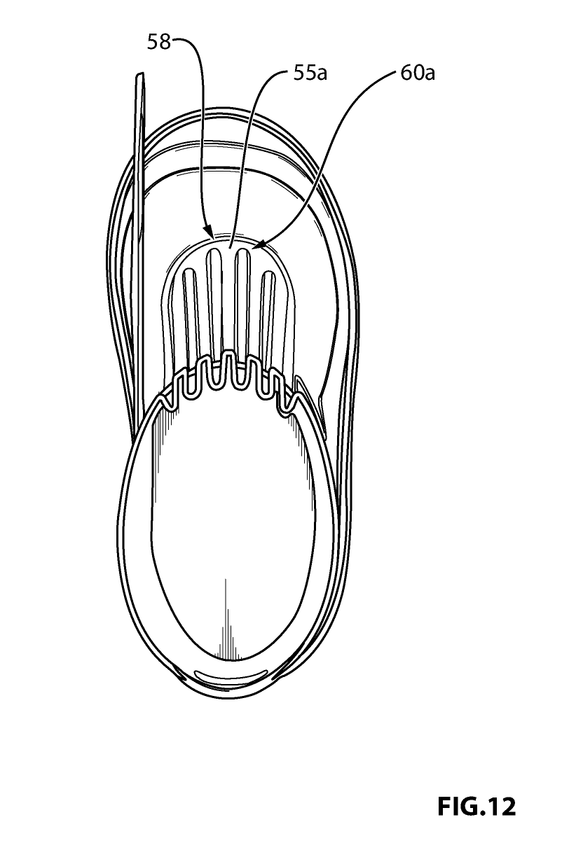

According to embodiments, the expansion portion is position in the tongue region of the overshoe and the expansion portion extends from the top of the overshoe body down towards a flexibility transition located on the upper portion of the overshoe body proximate the top of the user's foot. In some embodiments, as illustrated in FIG. 11, the expansion portion extends to position 60 at about the middle of the inner portion 55 which is defined by the flexibility transition 58. However, in other embodiments the expansion portion can extend to a position 60a that is closer to the flexibility transition 58, as illustrated in FIG. 12, thus reducing the area of the inner portion 55a. The extent to which the expansion portion 20 extends within the inner portion defined by the flexibility transition can be determined based on the desired expansion required in this specific region of the overshoe. For example the closer the expansion portion gets to the flexibility transition, the expansion of the overshoe in that area can be enhanced. A worker skilled art, would readily understand how to determine a desired level of expansion provided by the expansion portion and this can be based at least in part on the typical shoe type intended use of the overshoe, for example a running shoe, inherently has a thicker tongue when compared to a dress show. As such, more expansion may be required if the intended inner shoe is a running shoe, or alternately expansion required may be less if the intended inner shoe is a dress shoe. Moreover, if the overshoe is intended for more universal application with respect to inner shoes, then the expansion portion should be configured to provide the maximum required level of expansion needed by the intended inner shoes.

The cross sectional profile of the expansion portion can take on a variety of shapes provided that it substantially comprises accordion style folds. Having regard to FIG. 10 which illustrates an embodiment of the present invention, the accordion style folds comprise a plurality of adjacent planes 82, 84, which are interconnected by respective transitions 70, 72. In some embodiments, the folds can be configured with arcuate transitions 70, between proximate sides of the fold. In some embodiments the proximate sides of the folds can be interconnected by a substantially perpendicular portion 72 therebetween, thus providing a somewhat planar side to the fold. In some embodiments, the folds are configured substantially as a plurality of “V” shaped transitions, alternating between right side up “V”s and upside down “V”s. Other transition configurations would be readily understood by a worker skilled in the art.

According to embodiments, the expansion portion comprises a single format of transition for the accordion style folds. In other embodiments, a combination of different formats of transitions are provided for the accordion style folds, the selection of which can be determined based on interaction of the folds with different components of the overshoe, inner shoe or user's shin or leg, for example.

According to some embodiments, the transitions of the expansion portion facing the interior of the overshoe are arcuate in nature and the transitions of the expansion portion facing the exterior of the overshoe has a more planar face provided by transitions interconnecting proximate side are about perpendicular thereto, as illustrated in FIG. 10. For example, the arcuate transitions on the interior may provide for more comfortable contact with the user's shin, while the exterior transitions having a more planar nature may enhance the frictional retention of the accordion style folds in position by the fastening portion. In addition, this potential frictional interaction between the fastening portion and the expansion portion may at least in part reduce the securing force required to be provided by the securing mechanism.

The expansion portion is adapted to enable the overshoe body to reversibly acquire an open position and a closed position. When transitioning from the closed position to the open position, the accordion style folds deform elastically by bending or stretching or bending and stretching thus providing the desired level elongation of the expansion portion in order to acquire the open position. As this deformation is elastic in nature, the accordion style folds inherently return to their original shape, which is substantially the closed position of the accordion style folds. In some embodiments, depending on the level of forced expansion of the expansion portion, there may be resultant plastic deformation, and as such the expansion portion may not return fully to its original shape. The level of elasticity of the expansion portion can be directly related to the material from which it is fabricated, as well as the configuration of the accordion style folds. For example, if the accordion style folds are shallower in nature, a substantial portion of the deformation of the expansion portion may occur based on the stretching of the expansion portion, which may limit the level of expansion portion based on the type of material used therefor. In an alternate example, if the accordion style folds have a greater depth, a greater portion of the deformation of the expansion portion may occur based on the bending of the proximate sides and transitions of the accordion style folds, which may enhance the level of expansion of the expansion portion.

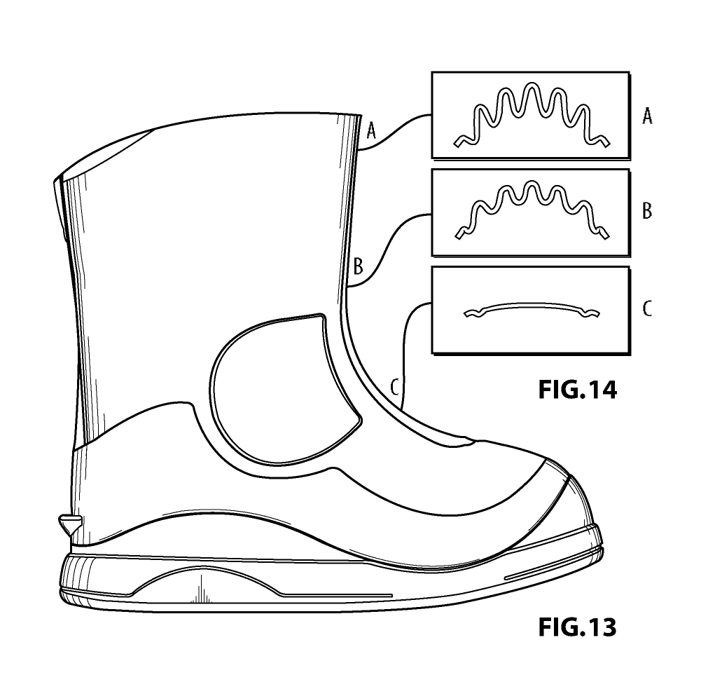

FIG. 13 illustrates a side view of the overshoe in accordance with embodiments of the present invention, wherein different locations along the expansion portion are identified. FIG. 14 illustrates cross sectional views of the expansion portion at these different locations in accordance with embodiments of the present invention. In accordance with some embodiments, and having regard to FIG. 14, the accordion style folds diminish in depth 90 and 91, along their length namely along the height of the overshoe. In this manner, the greatest amount of expansion of the overshoe is provided at the top of the upper portion of the overshoe.

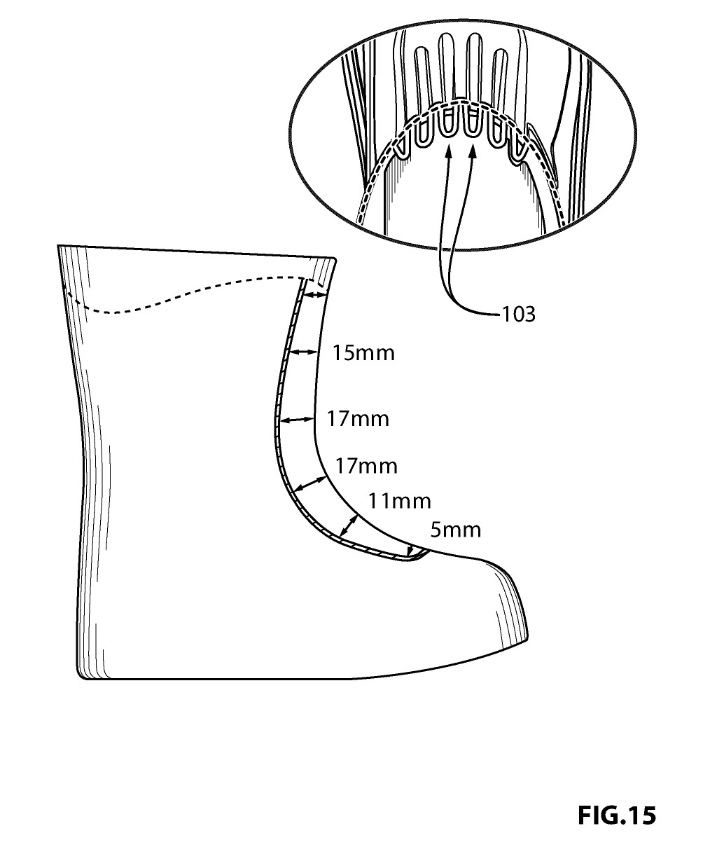

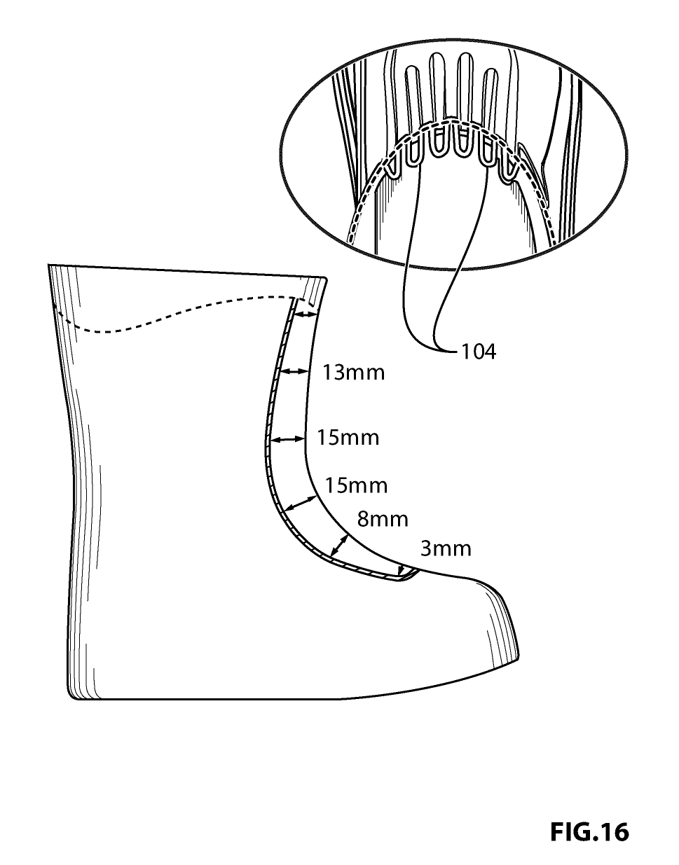

According to other embodiments, as illustrated in FIGS. 15 and 16, the accordion style folds vary in depth 100 and 101, as one travels down the height of the overshoe, while the largest depth of the accordion style folds is provided substantially at the position where the ankle of the user will be positioned upon complete insertion of the inner shoe and foot. The positioning of this substantially largest depth of the accordion style folds is approximately the location where, during the insertion of the inner shoe and foot, the movement of the foot transitions from plantarflexion to dorsiflexion. As such, the expansion portion is configured in order to mitigate binding of the inner shoe and foot within the overshoe during the transition between plantarflexion and dorsiflexion.

Having further regard to FIGS. 15 and 16 the accordion style folds vary in depth 100 and 101, over the cross section of the expansion portion. For example, the depth of the central two accordion style folds 103 (FIG. 15) is slightly larger than the thickness of the two adjacent accordion style folds 104 (FIG. 16). This variation of the depth of the accordion style folds can provide improved contact of the interior surface of the expansion portion and the outer surface of the top of the inner shoe. This improved contact between the inners shoe and the overshoe can enhance the interconnection therebetween, thereby reducing relative movement between the inner shoe and overshoe. As an example, by limiting relative movement between the inner shoe and the overshoe, the exterior surface of the inner shoe and the inner surface of the overshoe are protected from relative abrasion. In addition, with reduced relative movement, the user may fee a more sold connection between these inner shoe and overshoe, which may substantially mirror a feeling of a single “shoe” being used.

The expansion portion includes a plurality of accordion style folds. For ease of reference, a single accordion style fold can be considered to be one full wavelength, however as noted above, the accordion style folds can change in configuration along the cross section of the expansion portion. According to some embodiments, there are whole number accordion style folds defining the expansion portion, for example 2, 3, 4, 5, 6, 7, 8 or more accordion style folds. In some embodiments, there are half accordion style folds which are included in the expansion portion, for example 2½, 3½, 4½, 5½, 6½, 7½, 8½ or More accordion style folds.

According to embodiments of the present invention, the molded overshoe is composed from a single piece comprising various portions. The expansion portion of the overshoe functions to allow the opening of the overshoe to be expanded to allow for ease of receiving a foot wearing an inner shoe.

### Manufacturing the Overshoe

In accordance with embodiments of the present invention, the overshoe is intended to be waterproof. As such the overshoe may be made of material which is both impermeable and flexible. For example the overshoe may be made of latex, silicone or synthetic rubber, such as polyester urethane, polyurethane, thermoplastic polyether-ester or polyisoprene, thermoplastic elastomer or other material with the desired material properties, as would be readily understood by a worker skilled in the art.

In accordance with embodiments of the present invention, the expansion portion and the overshoe body are formed from separate components. In an alternative, the expansion portion and the overshoe body are integrally formed as a single unit. In yet other embodiments, the overshoe body, the expansion portion and the fastening portion are formed as a single component.

In some embodiments, the components of the overshoe are manufactured separately. For example the overshoe can be formed from three separate components, namely the overshoe body, the fastening portion and the expansion portion. In some embodiments, the overshoe is formed from two separate components. For example the overshoe body and the expansion portion are formed as a unitary component, while the fastening portion is separately formed. Alternatively, the overshoe body and the fastening portion are formed as a single component and the expansion portion is separately formed.

In accordance with embodiments of the present invention, the overshoe is manufactured and designed in order to provide different thicknesses in different regions. For example, regions that provide greater protection for a wearer and require greater structural rigidity, such as the sole portion of the overshoe, may have a greater thickness, when compared to regions requiring more flexibility, such as regions proximate to the user's metatarsal region.

In accordance with embodiments, the overshoe may be manufactured via one or more processes known in the art. For example, a person of skill in the art will understand that the components of the overshoe may be formed via injection molding, casting or compression molding or other methods as would be readily understood. It is also understood, that the components of the overshoe may be formed by the same process, or individual components of the overshoe may be formed by different processes. A person of skill in the art would also appreciate that different materials may be needed to achieve similar properties depending on the process of manufacture, for example the molding process used during fabrication. Moreover, a person of skill in the art would also appreciate that the thickness of a material used can be dependent on the process being used for manufacture.

In accordance with embodiments, where the overshoe is formed from two or more components, the adhering of the components together may be enabled by for example, thermal bonding, high frequency welding or via an appropriate adhesive substance known in the art. Specific bonding techniques and processes may be chosen with regards to the material from which the two or more components are manufactured.

In some embodiments, an appropriate adhesive substance may be styrene, acrylonitrile, adhesive cement or other appropriate adhesive substances as would be readily understood by a worker skilled in the art. It is readily understood, that the selection of the adhering technique or adhesive substance or both are selected in order to provide the desired interconnective strength between the components as well as a desired level of water impermeability as is necessary. For example, a suitable type of adhesion between the fastening portion and the overshoe body will likely be determined based on interconnective strength. While, a suitable type of adhesion between the expansion portion and the overshoe body will likely be determined by a combination of interconnective strength as well as water impermeability.

According to embodiments of the present invention, there is provided a method of fabricating an overshoe configured to receive a foot wearing an inner shoe. The overshoe comprises an overshoe body including a sole portion sealing connected with an upper portion. The overshoe further comprises an expansion portion sealingly and operatively coupled to the upper portion. The expansion portion is adapted to enable the overshoe body to reversibly acquire an open position for receiving the foot and inner shoe and a closed position wherein the overshoe encloses around the received foot and inner shoe. The expansion portion includes a plurality of accordion style folds. The method of fabricating the overshoe includes providing a mold having a cavity which defines the overshoe body and the expansion portion as a single unit. Subsequently an appropriate material is injected into the mold, such that the material fills the cavity. Upon sufficient solidification of the material within the mold, the mold is removed thereby exposing the completed overshoe.

According to some embodiments, the cavity of the mold further defines a fastening portion in an open position, wherein only a first end of the fastening portion is coupled to the upper portion.

According to some embodiments, the method further comprises attaching a first securing mechanism to a second end of the fastening portion and attaching a second securing mechanism to the upper portion of the overshoe body, wherein the first and second securing mechanisms are cooperative to provide a desired reversible connection between the upper portion and the second send of the fastening portion.

According to embodiments of the present invention, the molded overshoe is to be formed or molded using a single mold.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

1. An overshoe configured to receive a foot wearing an inner shoe, the overshoe comprising:
an overshoe body including a sole portion sealing connected with an upper portion; and
an expansion portion sealingly and operatively coupled to the upper portion, the expansion portion adapted to enable the overshoe body to reversibly acquire an open position for receiving the foot and inner shoe and a closed position wherein the overshoe encloses around the received foot and inner shoe, said expansion portion including a plurality of accordion style folds, said accordion style folds bias the expansion portion at least in part towards the closed position.

2. The overshoe according to claim 1, further comprising a fastening portion operatively connected to the overshoe body, the fastening portion configured to retain the expansion portion in the closed position.

3. The overshoe according to claim 2, wherein a first end of the fastening portion is fixedly secured to the upper portion at a first location and a second end of the fastening portion is reversibly secured to the upper portion at a second location.

4. The overshoe according to claim 3, wherein the second end of the fastening portion is reversibly secured to the upper portion using a hook and eye type fastener, a belt-buckle arrangement or a snap socket snap head combination.

5. The overshoe according to claim 3, wherein the second end of the fastening portion is hook and eye type fastener, which includes a hook portion provided over a first area and an eye portion provided over a second area, wherein the first area is greater than the second area or the second area is greater than the first area, thereby providing adjustment of a closure force applied by the fastening portion.

6. The overshoe according to claim 1, wherein the expansion portion includes accordion style folds which include a plurality of sides, wherein proximate sides connected by transitions, wherein said transitions are arcuate in shape.

7. The overshoe according to claim 1, wherein the expansion portion includes accordion style folds which include a plurality of sides, wherein proximate sides connected by transitions, wherein said transitions are linear and substantially perpendicular to the proximate sides.

8. The overshoe according to claim 1, wherein the expansion portion includes accordion style folds which include a plurality of sides, wherein proximate sides connected by transitions, wherein said transitions are configured substantially as a plurality of “V” shaped transitions, alternating between a right side up “V” and an upside down “V”.

9. The overshoe according to claim 1, wherein the expansion portion includes accordion style folds which include a plurality of sides, wherein proximate sides connected by transitions, wherein said transitions located at an exterior of the overshoe are linear and substantially perpendicular to the proximate sides and wherein said transitions located at an interior of the overshoe are arcuate in shape.

10. The overshoe according to claim 1, wherein the expansion portion includes accordion style folds which have a depth, wherein the depth increases along the expansion portion towards a top of the overshoe.

11. The overshoe according to claim 1, wherein the expansion portion includes accordion style folds which have a depth, wherein the depth varies along a length of the expansion portion.

12. The overshoe according to claim 11, wherein a largest depth of the accordion style folds is provided substantially at a position where an ankle of the user will be positioned upon complete insertion of the foot wearing the inner shoe into the overshoe.

13. The overshoe according to claim 11, wherein a largest depth of the accordion style folds is provided substantially a location where, during the insertion of the foot wearing the inner shoe, the movement of the foot transitions from plantarflexion to dorsiflexion.

14. The overshoe according to claim 1, wherein the expansion portion includes accordion style folds which have a depth, wherein the depth is sufficient for the expansion portion to engage with the inner shoe, thereby reducing relative movement of the overshoe and inner shoe during use.

15. The overshoe according to claim 9, further comprising a fastening portion operatively connected to the overshoe body, the fastening portion configured to retain the expansion portion in the closed position, wherein the transitions located at the exterior of the overshoe frictionally engage with the fastening portion.

16. The overshoe according to claim 1, wherein the overshoe is integrally formed as a single unit.

17. The overshoe according to claim 2, wherein the overshoe is integrally formed as a single unit.

18. A method of fabricating an overshoe configured to receive a foot wearing an inner shoe, the overshoe comprising an overshoe body including a sole portion sealing connected with an upper portion; and an expansion portion sealingly and operatively coupled to the upper portion, the expansion portion adapted to enable the overshoe body to reversibly acquire an open position for receiving the foot and inner shoe and a closed position wherein the overshoe encloses around the received foot and inner shoe, said expansion portion including a plurality of accordion style folds, the method comprising the steps of:
providing a mold having a cavity which defines the overshoe body and the expansion portion as a single unit;
injecting material into the mold; and
removing the mold.

19. The method of fabricating an overshoe according to claim 18, wherein the cavity further defines a fastening portion in an open position, wherein only a first end of the fastening portion is coupled to the upper portion.

20. The method of fabricating an overshoe according to 19, further comprising attaching a first securing mechanism to a second end of the fastening portion and attaching a second securing mechanism to the upper portion of the overshoe body, wherein the first and second securing mechanisms are cooperative to provide a desired reversible connection between the upper portion and the second send of the fastening portion.

21. A molded overshoe for receiving a foot wearing an inner shoe capable of acquiring at least one open position for receiving the foot and inner shoe and at least one closed position wherein the overshoe body is closed and may be secured around the received foot and inner shoe; the overshoe composed from a single piece comprising:
i. an expansion portion;
ii. a body portion;
iii. a sole portion; and
iv. a fastening portion;
wherein said overshoe is predisposed to acquire at least one closed position, wherein said expansion portion is capable of altering the configuration of the overshoe to acquire at least one open position allowing the insertion of a foot wearing an inner shoe, wherein, upon insertion of a foot wearing an inner shoe, the overshoe is predisposed to acquire at least one closed position, wherein said fastening portion is capable of securing the overshoe in at least one closed position while containing a foot wearing an inner shoe; wherein said sole portion comprises at least the portion of the overshoe in contact with the ground.

22. The overshoe of claim 21, wherein the expansion portion comprises a plurality of accordion folds allowing primarily lateral expansion of the overshoe.

23. The overshoe of claim 21, wherein the expansion portion is molded into and predisposed to form a plurality of accordion folds allowing primarily lateral expansion of the overshoe.

24. The overshoe of claim 22, wherein the expansion portion comprises 6 accordion folds toward the inner of the boot and 5 accordion folds toward the outer of the boot.

25. The overshoe of claim 22, wherein the accordion folds of the expansion portion are most acute and of largest amplitude in the area adjacent to the opening of the overshoe and decrease in acuteness and amplitude toward the sole portion of the overshoe.

26. The overshoe of claim 21, wherein the thickness of the overshoe material is constant throughout the body portion and the expansion portion.

27. The overshoe of claim 21, wherein the sole portion extends up the sides of the overshoe and wherein the thickness of the overshoe material is greater than the thickness of the material comprising the body portion and the expansion portion.

28. A method of producing a molded overshoe comprising the use of a single mold to form a molded overshoe composed from a single piece comprising portions with different material thicknesses.
